(19) United States
(12) Patent Application Publication
(10) Pub. No.: US 2024/0355047 A1
(43) Pub. Date: Oct. 24, 2024

(54) THREE DIMENSIONAL GAUSSIAN SPLATTING INITIALIZATION BASED ON TRAINED NEURAL RADIANCE FIELD REPRESENTATIONS

(71) Applicant: Intel Corporation, Santa Clara, CA (US)

(72) Inventors: Alexey M. Supikov, Santa Clara, CA (US); Sainan Liu, San Diego, CA (US); Niloufar Pourian, Los Gatos, CA (US)

(21) Appl. No.: 18/756,600

(22) Filed: Jun. 27, 2024

Related U.S. Application Data
(60) Provisional application No. 63/640,569, filed on Apr. 30, 2024.

(51) Int. Cl. G06T 17/00; G06T 7/90

(52) U.S. Cl. CPC G06T 17/00; G06T 7/90; G06T 2207/10024

(57) ABSTRACT

Example systems, apparatus, articles of manufacture, and methods are disclosed to implement three dimensional gaussian splatting initialization based on trained neural radiance field representations. Example apparatus disclosed herein determine a location for an initial three-dimensional (3D) gaussian splat based on optical densities obtained from a trained neural representation of a scene, the optical densities associated with location sample points along a training ray used to train the neural representation. Disclosed example apparatus also set parameters of the initial 3D gaussian splat based on one of the optical densities associated with the location of the initial 3D gaussian splat and a color value obtained from the trained neural representation, the color value associated with the location of the initial 3D gaussian splat, the initial 3D gaussian splat to be used to generate a 3D gaussian splat representation of the scene.

### RELATED APPLICATION(S)

This patent claims the benefit of U.S. Provisional Patent Application No. 63/640,569, which was filed on Apr. 30, 2024. U.S. Provisional Patent Application No. 63/640,569 is hereby incorporated herein by reference in its entirety. Priority to U.S. Provisional Patent Application No. 63/640,569 is hereby claimed.

### BACKGROUND

Machine learning models, such as neural networks, multi-layer perceptrons, etc., can be configured to implement a neural representation of a three-dimensional (3D) scene based on a set of two-dimensional (2D) images of the scene associated with a set of reference viewpoints. The neural representation, also referred to as a neural radiance field, is trained to encode structural and color information that can be used to render a 2D image of the scene from viewpoints that may be different from the reference viewpoints. A sequence of neural representations, or neural radiance fields, can also be trained to render respective video frames of a video of a 3D scene. As such, the sequence of neural representations, or neural radiance fields, form a neural video of the scene that can be rendered from different viewpoints and, thus, provide an immersive video experience.

Using three-dimensional gaussian splats (3DGS) to represent geometry and directional radiance distribution in a 3D scene has become popular due to remarkably high rendering speed. The 3DGS algorithm represents a scene as a collection of semi-transparent blobs of different sizes and orientations with directional radiance information encoded using spherical harmonics.

### BRIEF DESCRIPTION OF THE DRAWINGS

FIGS. 1A-1B illustrate details of an example neural network that implements an example neural representation of a scene.

FIG. 2 illustrates an example implementation of the neural network of FIGS. 1A-1B that corresponds to an example multi-layer perceptron (MLP).

FIG. 3 illustrates an implementation of an algorithm to generate a 3DGS representation of a scene.

FIG. 4 illustrates an example system including example 3DGS circuitry to generate a 3DGS representation of a scene, and an example 3DGS initialization circuit to utilize a trained neural representation of the scene to initialize the 3DGS representation in accordance with teachings of this disclosure.

FIG. 5 illustrates an example operation of the 3DGS initialization circuit of FIG. 2.

FIGS. 6 and 7A-7D are flowcharts representative of example machine readable instructions and/or example operations that may be executed, instantiated, and/or performed by example programmable circuitry to implement the 3DGS initialization circuit of FIG. 4.

FIG. 8 is a block diagram of an example processing platform including programmable circuitry structured to execute, instantiate, and/or perform the example machine readable instructions and/or perform the example operations of FIGS. 6 and 7A-7D to implement the 3DGS initialization circuit of FIG. 4.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine readable instructions of FIGS. 6 and 7A-7D) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Images, audio, video, 3D objects, and most media, are typically captured and represented by discrete samples. For example, an image is typically represented as a grid of discrete samples, such as an array of pixels, where each pixel has numbers representing the intensity at that image location in red, green, and blue. In contrast, a neural representation is a neural network that stores content, such as an image, in the weights and structure of the neural network. Neural representations are becoming ubiquitous in visual computing because they offer advantages in compactness and continuous representations. In particular, they enable a new way to represent and render photorealistic depictions of a real scene, given several photos of that scene, by enabling joint reconstruction and encoding of three-dimensional (3D) scene complex geometry and radiance distribution from a set of two-dimensional (2D) color images taken from different viewpoints. For example, such a neural network may receive (x, y, z) coordinates as input and output (R, G, B) pixel values that represent a color distribution in a 3D scene.

Neural Radiance Fields (NeRFs) are a specific neural representation that trains a neural network (e.g., a multilayer perceptron (MLP)) to represent the appearance of a 3D scene. A NeRF takes as input several images of a static scene, where the cameras are at known locations, and uses deep learning techniques to train the neural network to implement a neural representation of that scene. Rendering an image from a NeRF is done through volume rendering, which involves repeated queries of the neural network to determine color and opacity at many points along rays emanating from an input location, such as input (x, y) coordinates.

More recently, three-dimensional (3D) gaussian splats (3DGS) algorithms to represent geometry and directional radiance distribution in a 3D scene have been developed as an alternative to neural representations, such as NeRF, due to remarkably high rendering speed. A 3DGS algorithm generates a 3DGS representation of the 3D scene as a collection of semi-transparent blobs of different sizes and orientations with directional radiance information encoded using spherical harmonics.

Once created, the blobs (also referred to as gaussian splats, splats or gaussians) can be efficiently projected and rasterized (e.g., at a speed of hundreds of frames per second). However, generating the 3DGS representation from input (e.g., training) multi-view images can be substantially slower (e.g., taking 30 minutes to 1 hour) than training neural representations of the same scene, such as volumetric, hybrid volumetric, MLP representations, etc. (e.g., which can take on the order of minutes).

The generation speed and quality of a 3DGS representation depends on the initialization of the gaussian locations and parameters. Disclosed examples perform 3DGS initialization techniques that enable generation of a 3DGS representation up to an order of magnitude faster than prior techniques. One prior approach distributes initial gaussians randomly in a volume of interest. Such random initialization can lead to long training times as the 3DGS algorithm moves the initial gaussians towards the scene geometry by balancing densification and pruning. Furthermore, such random initialization sometimes results in the 3DGS algorithm failing to converge.

Another prior approach uses correspondence points identified in training images by a structure from motion (SfM) algorithm typically used during camera calibration. This SfM-based approach can improve convergence properties and speed up training, but requires re-running the SfM algorithm for every new scene even if the multi-camera system is already calibrated. Thus, the total time for generating a 3DGS representation using SfM-based initialization can still be relatively long (e.g., in the 30-60+ minute range).

In contrast with the prior approaches described above, disclosed example 3DGS initialization techniques provide a fast way to create a high-quality approximation of an initial distribution of gaussian splats. Disclosed examples first train an example neural radiance field representation amenable to fast training (e.g., such as InstantNGP, Plenoxels, K-Planes, etc.) and use the trained neural representation to seed the gaussians with almost correct positions, densities, and colors. For example, after the trained neural representation is created, disclosed examples use a trained neural representation to re-trace the training rays (or the subset of thereof) to skip empty space and generate a large number of gaussians from ray marching samples near scene geometry. In this way, disclosed examples can solve the problem of slow training of a 3DGS representation by providing an initial distribution of gaussian splats that enables a 3DGS algorithm to converge quickly (e.g., reducing overall training time from ˜1 hour to 5-8 minutes for high quality representations, and from 8-12 minutes to 1-2 minutes for medium quality representation).

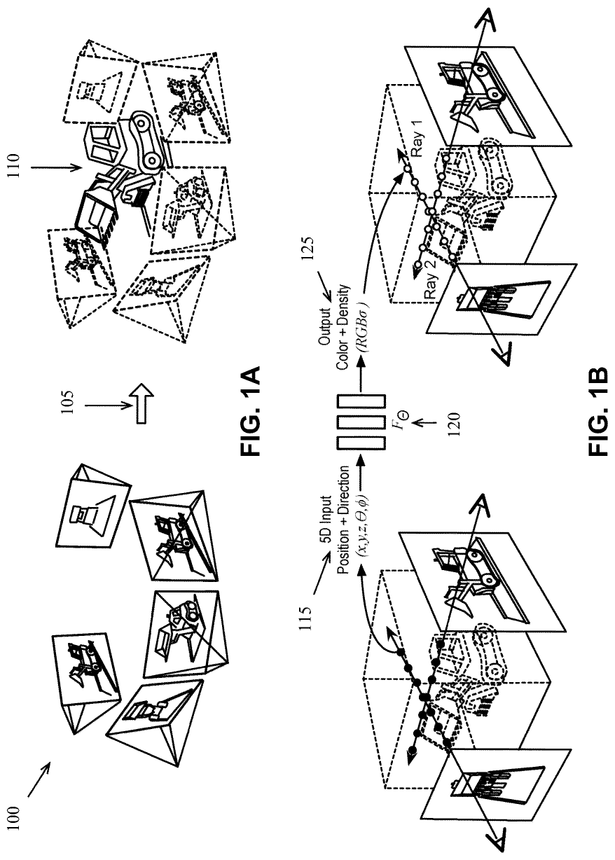

As example 3DGS initialization techniques disclosed herein rely on a trained neural representation of a scene, FIGS. 1A-1B illustrate details of such an example neural representation in the form of an example NeRF neural network. FIG. 1A shows conceptual diagrams of training a NeRF. FIG. 1B shows input and output details of a NeRF neural network. As shown in FIG. 1A, several images 100 may be taken of a three-dimensional scene from known locations. A training operation 105 can be performed to build a neural representation of that three-dimensional (3D) scene from those images. The trained neural representation is a NeRF that represents the scene via the weights of the neural network model. The NeRF can be used to render the scene 110 from viewpoints other than the viewpoints of the input images. As shown in FIG. 1B, a trained NeRF can receive a five-dimensional (5D) input 115 that includes a 3D position (x, y, z) and a 2D direction (θ and Φ) The NeRF can be a neural network 120 (F_{θ}), such as an MLP, that is trained to produce an output 125 color value (R,G,B) and density σ in response to the 5D input 115. Volume rendering techniques can repeatedly access the neural network 120 to render the 3D scene from an arbitrary viewpoint to accumulate colors and densities into a 2D image.

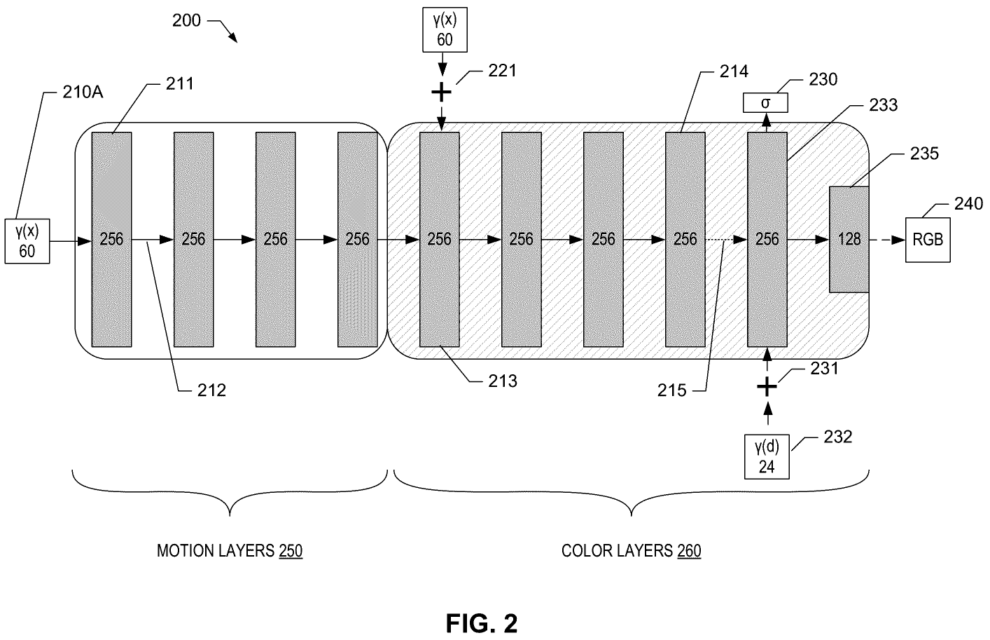

FIG. 2 illustrates an example neural network 200 that implements an MPL that can be trained to provide neural representations (e.g., NeRFs) of static 3D scenes, 3D videos (e.g., INVs), etc. The neural network 200 is an MLP, which is a fully connected neural network that is used for NeRF implementations. In the illustrated example, the neural network 200 includes multiple fully connected layers 211, each with 256 channels and an example rectified liner unit (ReLU) activation function 212. An example positional input 210A (γ(x), e.g., 3D-position (x, y, z)) is provided at the first fully connected layer 211 and propagates through eight fully connected layers. An additional instance of the positional input 210B is provided via a skip connection to an example fifth fully connected layer 213. The positional input 210B is combined with the fifth fully connected layer 213 via vector concatenation using an example combining function 221. An example eighth fully connected layer 214 outputs a first example output layer 233, which outputs an example volume density 230 for the position γ(x) and a 256-dimension feature vector. The 256-dimension feature vector is concatenated via an example combining function 231 with an example viewing direction 232 (γ(d), e.g., 2D direction (θ, Φ)) and processed via a second example output layer 235 to generate an example RGB value 240 for the position γ(x) when viewed from direction γ(d). Instead of using positions x and direction d inputs directly, the neural network 200 applies an encoding function γ to convert 3 position coordinates x to multichannel inputs with 60 channels for position, and to convert 2 direction coordinates d to 24 channels for direction, for example. The use of encoding function can improve the ability of the neural network to represent high frequencies. Examples of the encoding function y include frequency encoding, Fourier features, multi-resolution hash tables, etc.

The neural network 200 enables the synthesis of new images of a 3D scene as seen from a desired viewpoint at a specific time, even if that viewpoint was not directly captured by a video camera. The neural network 200 also supports INV. As described above, the INV approach takes as input multiple video streams with camera parameters (e.g., intrinsic and/or extrinsic parameters) for each stream, where each stream captures the same scene from a different viewpoint. INV maintains a NeRF-like MLP, such as the neural network 200, that is up to date with the current timestamp of the video streams. The NeRF-like MLP 200 is incrementally updated for each incoming time frame (corresponding to multiple views in space). Incremental training uses MLP weights from the previous frame to train the MLP 200 for the next frame. Therefore, the MLP 200 can automatically re-use learning from previous frames and adjusts the MPL layer weights for a new frame. In this frame-to-frame incremental training mode, the MLP weights exhibit the following behavior: the front layers change from frame to frame, whereas the back layers change slowly or remain unchanged. Such behavior happens spontaneously in the INV NeRF MPL 200. As described above, experiments have shown that the front layers 250 of the MPL 200 are mainly responsible for encoding motion/deformation, whereas the back layers 260 mainly encode color of the 3D scene fragments.

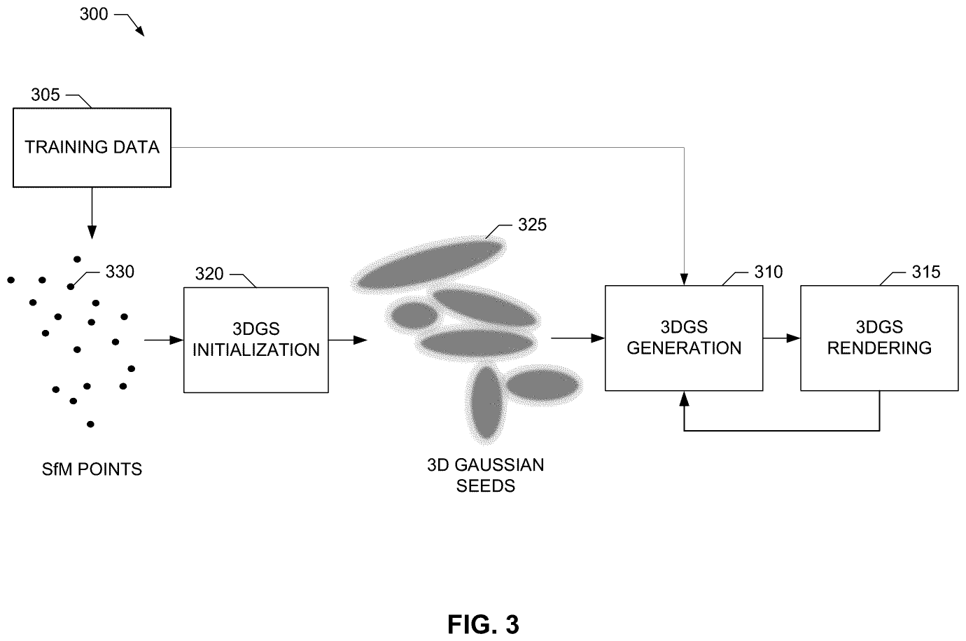

FIG. 3 illustrates an implementation of an example 3DGS algorithm 300 to generate a 3DGS representation of a 3D scene. The 3DGS algorithm 300 generates the 3DGS representation based on example training data 305, which includes training images of the scene from multiple views, and camera parameters associated with cameras the generate the training images from the multiple view. In particular, the 3DGS algorithm 300 of FIG. 3 includes an example 3DGS generation component 310 and an example 3DGS rendering component 315 to generate the 3DGS representation of the scene based on the training data 305.

For example, the 3DGS generation component 310 operates to generate a set of 3D gaussian splats (also referred to a 3D gaussians or 3D splats) based on the training data to represent the scene, and the 3DGS rendering component 115 operates to render the scene from a particular viewpoint (e.g., which may be different from the viewpoints of the training images) based on the generated set of 3D gaussian splats. The 3DGS generation component 310 iteratively generates, or trains, the 3D gaussian splats by comparing scenes rendered by the 3DGS rendering component 115 using current iterations of the 3D gaussian splats to corresponding ground truth versions of the scene provided by the training data 305. The 3DGS generation component 310 utilizes a loss function to update parameters of the 3D gaussian splats based on the comparisons. Examples of 3D gaussian parameters updated by the 3DGS generation component 310 include a location of a given 3D gaussian splat, a color of the given 3D gaussian splat, an opacity of the given 3D gaussian splat, a covariance matrix for the given gaussian splat (e.g., which specifies the shape, such scaling and rotation, of the gaussian splat), and an activation value for the given 3D gaussian splat (e.g., which is used by the 3DGS generation component 310 when training the 3D gaussian splats).

The 3DGS algorithm 300 of FIG. 3 also includes an example 3DGS initialization component 320 to determine a set of initial gaussian splats 325 (also referred to as gaussian seeds 325) to initialize the 3DGS generation component 110. In the illustrated example, the 3DGS initialization component 320 uses an SfM-based approach to determine the set of initial gaussian splats 325 based on example SfM points 330 determined from the training data 305. For example, the 3DGS initialization component 320 initializes the set of initial gaussian splats 325 to have a respective splat for each of the SfM points 330. Then, the 3DGS initialization component 320 sets the location of a given initial gaussian splat 325 based on (e.g., equal to, as a function of, etc.) the location of a corresponding SfM point 330, sets the opacity of the given initial gaussian splat 325 based on (e.g., equal to, as a function of, etc.) the opacity and/or other related value of the corresponding SfM point 330, and sets the color of the given initial gaussian splat 325 based on the color of the corresponding SIM point 330. For example, if the 3DGS algorithm 300 represents the color of a given 3D gaussian splat using spherical harmonics, the 3DGS initialization component 320 may set the zero-order spherical harmonic coefficient of the color of the given initial gaussian splat 325 based on (e.g., equal to, as a function of, etc.) the color of the corresponding SfM point 330.

In the illustrated example, the 3DGS initialization component 320 also initializes the covariance matrix of a given initial gaussian splat 325 based on an activation scale parameter that causes the given initial gaussian splat 325 to be an isotropic gaussian with equal axes in the three dimensions. For example, the 3DGS initialization component 320 may set the activation scale parameter for the given initial gaussian splat 325 to be equal to a mean value of the three closest SfM points to the particular SfM point 330 corresponding to the given initial gaussian splat 325. After the 3DGS initialization component 320 determines the set of initial gaussian splats 325 (e.g., including the number of initial splats and their respective locations/positions and other parameters), the 3DGS generation component 110 generates the 3DGS representation of the scene, as described above.

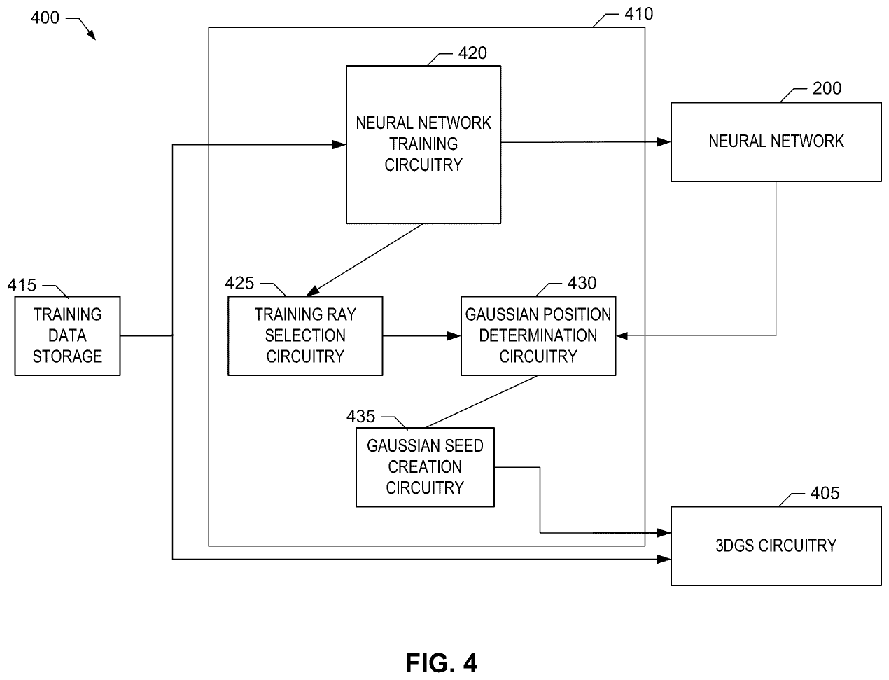

FIG. 4 illustrates an example system 400 including example 3DGS circuitry 405 to generate a 3DGS representation of a scene, and an example 3DGS initialization circuit 410 to utilize a trained neural representation of the scene implemented by the neural network 200 to initialize the 3DGS representation in accordance with teachings of this disclosure. The 3DGS circuitry 405, the 3DGS initialization circuit 410, the neural network 200 and/or, more generally, system 400 of FIG. 4 may be instantiated (e.g., creating an instance of, bring into being for any length of time, materialize, implement, etc.) individually or collectively (in any combination) by programmable circuitry such as a Central Processor Unit (CPU) executing first instructions. Additionally or alternatively, the 3DGS circuitry 405, the 3DGS initialization circuit 410, the neural network 200 and/or, more generally, system 400 of FIG. 4 may be instantiated (e.g., creating an instance of, bring into being for any length of time, materialize, implement, etc.) individually or collectively (in any combination) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

In the illustrated example of FIG. 4, the 3DGS circuitry 405 implements the 3DGS generation component 310 and the 3DGS rendering component 315 to generate a 3DGS representation of a scene based on training data stored in example training data storage 415. In the illustrated example, the training data storage 415 can be implemented by any number and/or types of storage devices, memories, etc., and stores training data including multiple images captured from different viewpoints of a 3D scene (also referred to herein as multi-view images), multiple video streams from different viewpoints of the 3D scene (also referred to herein as multi-view video streams), camera parameters associated with cameras the generate the training images from the multiple views, etc. The 3DGS circuitry 405 implements the 3DGS generation component 310 and the 3DGS rendering component 315, as described above, to generate the 3DGS representation of the scene based on the training images and camera parameters, as described above.

However, unlike the 3DGS algorithm of FIG. 3, which used an SfM-based approach to determine the initial set of 3D gaussian splats to be used to initialize the 3DGS generation component 310, the system 400 of FIG. 4 includes the 3DGS initialization circuit 410 to utilize a trained neural representation of the scene implemented by the neural network 200 to determine the initial set of 3D gaussian splats. Neural representations, such as NeRFs, which represent optical density and directional radiance distributions in 3D space with a structure that can be overfitted (trained) from images of content taken from different viewpoints, have become a basis for a wide spectrum of different algorithms and representations. As described above, 3DGS can offer high visual quality and fastest rendering times, but training a 3DGS representation from scratch can be slow. In contrast, neural representations (e.g., NeRFs) and other neural algorithms based on volumetric, factorized or hybrid representations can be trained quickly, but rendering using the trained neural representation can be slow as they involve performing ray marching and querying the representation in many points in 3D space.

3DGS initialization as implemented by the example 3DGS initialization circuit 410 exploits the fast training capabilities of hash grids and neural radiance field representations, which allow spatial queries of optical density/opacity and possibly radiance/color values or equivalents of such values, to create a neural representation of a 3D scene from multiple input images. The 3DGS initialization circuit 410 then uses this trained neural representation to populate a relatively dense set of initial 3D gaussian splats that correspond closely to the actual geometry of the modelled 3D scene. The resulting initial set of 3D gaussian splats is used as a starting point by the 3DGS circuitry 405 to generate the 3DGS representation of the scene, as described above. With such a starting point, the 3DGS circuitry 405 can converge to the 3DGS representation substantially faster than prior approaches, as the overall training time is dramatically reduced.

To achieve this functionality, the 3DGS initialization circuit 410 includes example neural network training circuitry 420, example training ray selection circuitry 425, example gaussian position determination circuitry 430 and example gaussian seed creation circuitry 435. The 3DGS initialization circuit 410 begins operation based on a set of views of a 3D scene taken from different viewpoints with extrinsic and intrinsic camera parameters (e.g., corresponding to training views), which are accessed from the training data storage 415. The 3DGS initialization circuit 410 invokes the neural network training circuitry 420 to train the neural network 200 to create a neural radiance field representation that allows spatial queries of optical density/opacity and possibly radiance/color values or equivalents of such values from training views. For example, an InstantNGP representation (e.g., such as a cascade of hash grids and an MLP representation) or a NerfAcc representation can be created from training views. In some such examples, the NerfAcc training can be run until a convergence criterion is met, such as until a test image reaches a pre-defined peak signal to noise ratio (PSNR) (e.g. 29 dB or some other value). In some examples, any other radiance field representation can be implemented by the neural network 200 and trained by the neural network training circuitry 420 accordingly.

For example, the neural network training circuitry 420 may implement any appropriate neural network training technique or combination of techniques to train the layer weights of the neural network 200 to implement a neural representation of a 3D scene based on the training data stored in example training data storage 415. For example, the neural network training circuitry 420 can implement forward propagation techniques, backward propagation techniques, etc., or any combination thereof, to incrementally train the neural network 200 based on the multi-view video streams stored in the training data storage 325 to implement an INV that outputs a stream of NeRFs that enable video frames to be rendered from viewpoints other than the viewpoints of the input multi-view video streams. Further example training techniques that can implemented by the neural network training circuitry 420 are described in U.S. Patent Publication No. 2024/0135483, which is titled “INCREMENTAL NEURAL REPRESENTATION FOR FAST GENERATION OF DYNAMIC FREE-VIEWPOINT VIDEOS,” and which was published on Apr. 25, 2024.

In the illustrated example of FIG. 4, the neural network 200 implements a NeRF, which is a technique for representing geometry and directional lighting information of a 3D scene. It is based on a positional neural representation (a combination of grids, hash grids and neural networks, such as an MLP) that takes 3D position of a point and a direction vector as input and produces optical density (e.g., opaqueness) at that point and radiance leaving the point at the given direction. The resulting representation is compact and expressive, enabling photorealistic depictions of highly detailed 3D scenes. NeRFs can also be generalized to other types of geometrical and non-geometrical data, such as signed distance functions, electromagnetic fields, etc.

Once trained by the neural network training circuitry 420, the neural network 200 can render images of a 3D scene from an arbitrary viewpoint using volume rendering via ray marching. Ray marching involves casting rays for every image pixel, sampling the neural network at the points along the ray and accumulating transparency and weighted radiance to produce a final pixel color.

The neural network training circuitry 420 trains the neural network 200 to implement a neural representation a NeRF that fits 3D scene data from images taken from different viewpoints with reference (e.g., known) camera parameters. Such training views are used by the neural network training circuitry 420 to generate training rays. During training, the neural network training circuitry 420 invokes the neural network 200 to perform volume rendering using training rays to generate pixel colors that are compared against ground truth pixel colors in the training data. The neural network training circuitry 420 uses the color difference in a loss function to adjust the weights of the neural network 200.

Volume rendering involves querying the underlying neural network 200 at multiple points along a ray. Millions of rays may be used during training and rendering, resulting in hundreds of millions of network queries. To address the computational complexity, some volume rendering techniques have focused on making each query cheaper (e.g., by simplifying the underlying MLPs) and/or reducing the number of queries by skipping sampling points that hit empty space using occupancy grids.

After the neural representation implemented by the neural network 200 is trained by the neural network training circuitry 420, the 3DGS initialization circuit 410 invokes the training ray selection circuitry 425 to create a subset of training rays to cover the 3D scene, with the number of rays corresponding to a number (e.g., pre-defined) of initial 3D gaussians, N_{g} (e.g., N_{g}=300K or some other value). For example, the training ray selection circuitry 425 can create the subset of training rays as follows. Given a set of training images (e.g., selected randomly or provided as input) used to train the neural network 200, and a corresponding set of trainings rays used to train the neural network 200 based on the set of training images, in some examples, the training ray selection circuitry 425, optionally downsamples the training images from the set (e.g. by the factor of 2, 4 or some other value in each dimension), and downsamples the set of training rays accordingly. Additionally or alternatively, in some examples, if training images contain a background (e.g., empty space) mask, the training ray selection circuitry 425 retains only those training rays that intersect foreground pixels (e.g., with such pruning allowing for skipping the downsampling of the training images and the mask). In some examples, the training ray selection circuitry 425 generates a random permutation of the (pruned) set of training rays by, for example, indexing the training rays (or pixels in the training images) in the set and generating a random permutation of the indices. In some examples, the training ray selection circuitry 425 then selects N_{g} indices from the permutation and generates the subset of N_{g} training rays corresponding to the indices.

Next, the 3DGS initialization circuit 410 invokes the gaussian position determination circuitry 430 to generate 3D gaussian position candidates from the subset of training rays generated by the training ray selection circuitry 425. In some examples, the gaussian position determination circuitry 430 traces the subset of N_{g} training rays using ray marching and selects one location sample point per ray based on density (e.g., by selecting the location sample point with the maximum density) obtained from the neural network 200 for the location sample points along the ray. In some examples, the gaussian position determination circuitry 430 uses the queried densities obtained from the neural network 200 to discard far samples based on one or more early stop criteria.

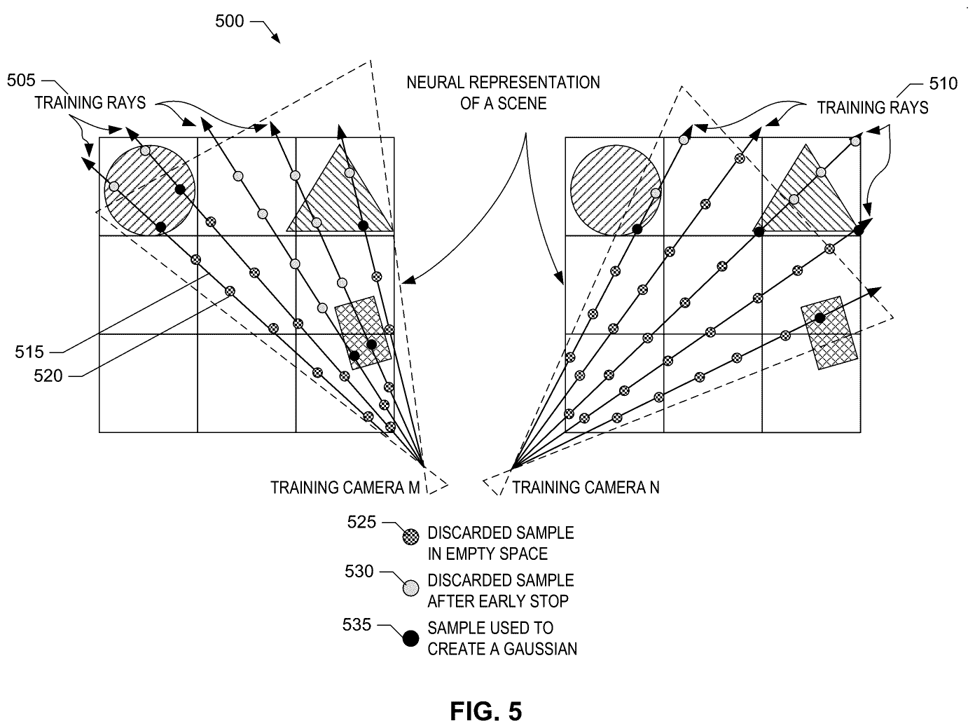

FIG. 5 illustrates an example operation 500 of the gaussian position determination circuitry 430 to generate 3D gaussian position candidates from a subset of training rays used to train the neural network 200. In the illustrated example of FIG. 5, the subset of training rays includes a first example subset 505 of training rays associated with a first training image corresponding to a first viewpoint, and a second example subset 510 of training rays associated with a first training image corresponding to a first viewpoint. The gaussian position determination circuitry 430 dices the training rays 505 and 510 into segments based on an example segment length 515 (which may be a configurable parameter) and generates example location sample points 520 along the training rays 505 and 510 using any appropriate ray marching algorithm. In some examples, the gaussian position determination circuitry 430 removes those location samples points, such as the location sample point 525, corresponding to empty space (e.g., as identified using an occupancy grid).

Next, the gaussian position determination circuitry 430 queries the trained neural representation implemented by the neural network 200 for optical density at the remaining location sample points 520. In some examples, the gaussian position determination circuitry 430 discards those location sample points, such as the example location sample points 530, beyond an example early stop transparency threshold. Then, for each training ray 505 and 510, the gaussian position determination circuitry 430 selects one location sample point, such as location sample points 535, based on density (e.g., with the maximum density), and discards the rest of the location sample points for that training ray. The gaussian position determination circuitry 430 then sets the selected location sample point for each training ray, represented by the variable Xᵢ for the i^{th} training ray, to be the initial location/position of a corresponding initial 3D gaussian splat, represented by the variable Gᵢ, in the set of initial 3D gaussian splats.

After the gaussian position determination circuitry 430 determines the location sample points Xᵢ for the initial 3D gaussian splats, the 3DGS initialization circuit 410 invokes the gaussian seed creation circuitry 435 to generate the set of initial 3D gaussian splats based on those location sample points. In some examples, for each location sample point Xᵢ selected by the gaussian position determination circuitry 430, the gaussian seed creation circuitry 435 performs a query of the trained neural representation implemented by the neural network 200 for density and color using the position of that location sample point Xᵢ and the direction of the correspondent training ray. The gaussian seed creation circuitry 435 also obtains the length of the ray segment where the sample is located (e.g., from the gaussian position determination circuitry 430). Using that information, the gaussian seed creation circuitry 435 associates each selected location sample point Xᵢ with a position (xᵢ, yᵢ, zᵢ), a ray segment length δᵢ, a density δᵢ and a color (rᵢ, gᵢ, bᵢ).

Next, for each selected location sample point Xᵢ, the gaussian seed creation circuitry 435 creates an initial 3D gaussian splat Gᵢ, also referred to as a seed gaussian Gᵢ, with mean set to (xᵢ, yᵢ, zᵢ), a diffuse color (e.g., zero-order spherical harmonic coefficient) sct to (rᵢ, gᵢ, bᵢ), and a post-activation opacity set to αᵢ=1−exp (−σᵢδᵢ). In some examples, the gaussian seed creation circuitry 435 also sets sigmoid pre-activation value aᵢ for a given 3D gaussian splat Gᵢ based on its post-activation opacity αᵢ to be aᵢ=−ln1-αᵢ/αᵢ. In some examples, the gaussian seed creation circuitry 435 sets the post-activation scale Sᵢ of the covariance matrix for the given 3D gaussian splat Gᵢ to the mean distance to the three (3) closest selected location sample points to Xᵢ. However, in some examples, the gaussian seed creation circuitry 435 sets the post-activation scale Sᵢ of the covariance matrix for the given 3D gaussian splat Gᵢ as 0.5δᵢ (or some other fraction of the segment distance) in all 3 directions (e.g., depending on preference of faster training vs. faster initialization and number of seed gaussians). In some examples, the gaussian seed creation circuitry 435 sets a rotation Rᵢ of the covariance matrix for the given 3D gaussian splat Gᵢ to be small random deviation from identity rotation.

After the gaussian seed creation circuitry 435 generates the set of initial 3D gaussian splats {Gᵢ}_{i=0 . . . N}_{_{g}}, the 3DGS circuitry 405 generates a 3DGS representation of the scene based on that set of initial 3D gaussian splats {Gᵢ}_{i=0 . . . N}_{_{g}}, as described above. As a result of having a good starting approximation, the 3DGS circuitry 405 can converge quickly to a final 3DGS representation (e.g., within 30-60 seconds) with PSNR values higher than prior techniques.

In some examples, the gaussian seed creation circuitry 435 implements an enhancement that improves the scale selection for the initial 3D gaussians to better follow the scene geometry by “squishing” the initial 3D gaussians in the direction of an estimated surface normal. In some examples, the gaussian seed creation circuitry 435 achieves this by computing a non-uniform scale and a rotation from a normal approximation generated from a spatial gradient of density computed at a given gaussian location. For example, the gaussian seed creation circuitry 435 can introduce the non-uniform scale by setting the scale for a given 3D gaussian splat Gᵢ as Sᵢ = (0.5S, S, S), where S is found as described above, and by setting rotation Rᵢ so that it turns the local x-axis of the given 3D gaussian splat Gᵢ towards the normal estimate.

In some examples, the gaussian seed creation circuitry 435 computes higher order spherical harmonics for the color of a given 3D gaussian splat Gᵢ by sampling radiance at the sample Xᵢ in multiple directions in a hemi-sphere around an estimated surface normal or in the sample's ray direction (e.g., if the normal is not available). In some examples, only the color head of the MLP implemented by the neural network 200 is re-computed for new directions as the geometry feature vector is generated by the full query.

In view of the foregoing, in some examples, the 3DGS initialization circuit 410 operates to generate a set of initial 3D gaussian splats as follows. The gaussian position determination circuitry 430 determines a location for an initial 3D gaussian splat based on optical densities obtained from a trained neural representation of a scene (e.g., implemented by the neural network 200), with the optical densities associated with location sample points along a training ray used to train the neural representation. In some such examples, the gaussian seed creation circuitry 435 sets parameters of the initial 3D gaussian splat based on one of the optical densities associated with the location of the initial 3D gaussian splat and a color value obtained from the trained neural representation, with the color value associated with the location of the initial 3D gaussian splat, and the initial 3D gaussian splat to be used (e.g., by the 3DGS circuitry 405) to generate a 3D gaussian splat representation of the scene.

In some examples, the gaussian position determination circuitry 430 determines the location of the initial 3D gaussian splat to be a first one of the location sample points along the training ray that is associated with a largest one of the optical densities. In some such examples, the gaussian seed creation circuitry 435 queries the trained neural representation based on the first one of the location sample points and a direction of the training ray to obtain the color value associated with the location of the initial 3D gaussian splat. In some such examples, the gaussian seed creation circuitry 435 sets a mean of the initial 3D gaussian splat based on the first one of the location sample points along the training ray.

In some examples, the gaussian seed creation circuitry 435 sets a zero order spherical harmonic parameter of the initial 3D gaussian splat based on the color value obtained from the trained neural representation.

In some examples, the location sample points are based on a segment length used to sample the training ray, and the gaussian seed creation circuitry 435 sets a post-activation opacity parameter of the initial 3D gaussian splat based on the segment length and the one of the optical densities associated with the location of the initial 3D gaussian splat.

In some examples, the location sample points are based on a segment length used to sample the training ray, and the gaussian seed creation circuitry 435 sets a post-activation scale parameter of the initial 3D gaussian splat based on the segment length.

In some examples, the initial 3D gaussian splat is a first initial 3D gaussian splat, the training ray is a first training ray, and the training ray selection circuitry 425 selects a subset of training rays from a plurality of training rays used to train the neural representation, with a number of training rays in the subset corresponding to a number of initial 3D gaussian splats in a set of initial 3D gaussian splats to be used to generate the 3D gaussian splat representation of the scene, and the subset of training rays including the first training ray. In some such examples, the gaussian seed creation circuitry 435 generates the set of initial 3D gaussian splats based on the subset of training rays, with ones of the set of initial 3D gaussian splats corresponding respectively to ones of the subset of training rays, and the set of initial 3D gaussian splats including the first 3D gaussian splat. In some such examples, the 3DGS circuitry 405 generates the 3D gaussian splat representation of the scene based on the set of initial 3D gaussian splats and training images corresponding to multiple view of the scene, with the training images having been used to train the neural representation of the scene. In some such examples, the subset of training rays includes a first subset of training rays corresponding to a first one of the views and a second subset of training rays corresponding to a second one of the views.

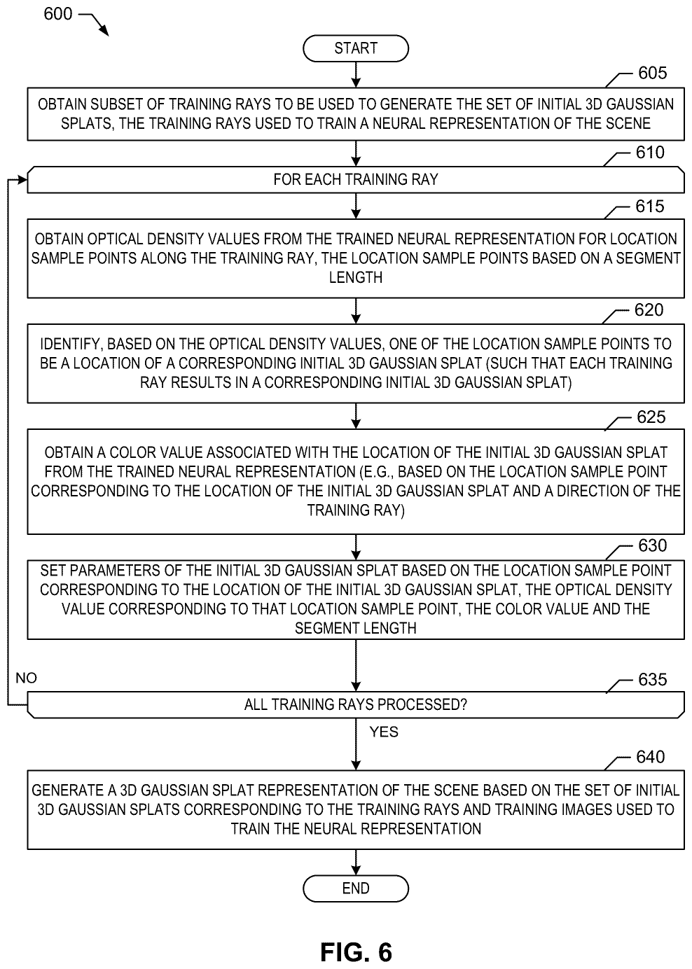

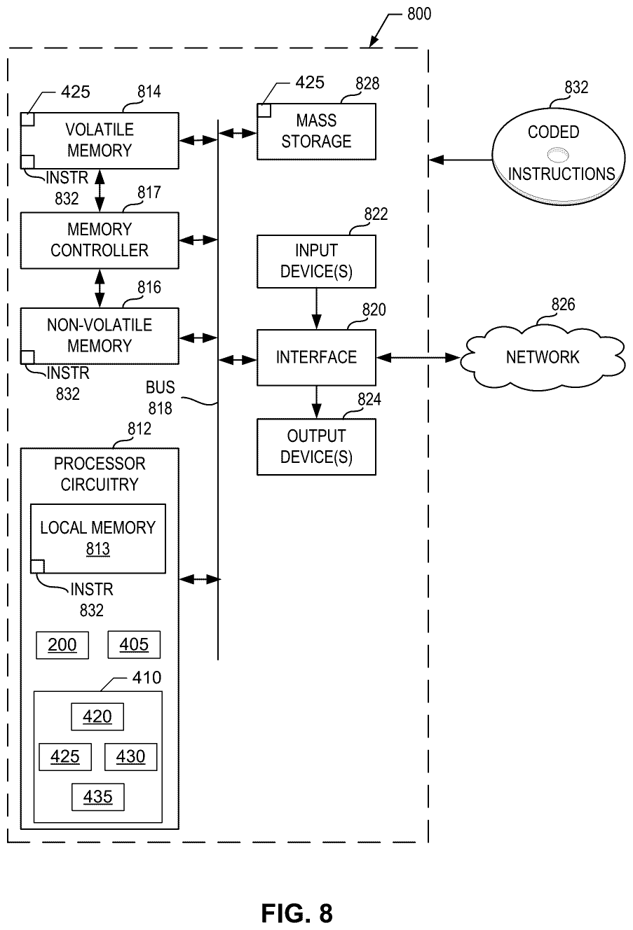

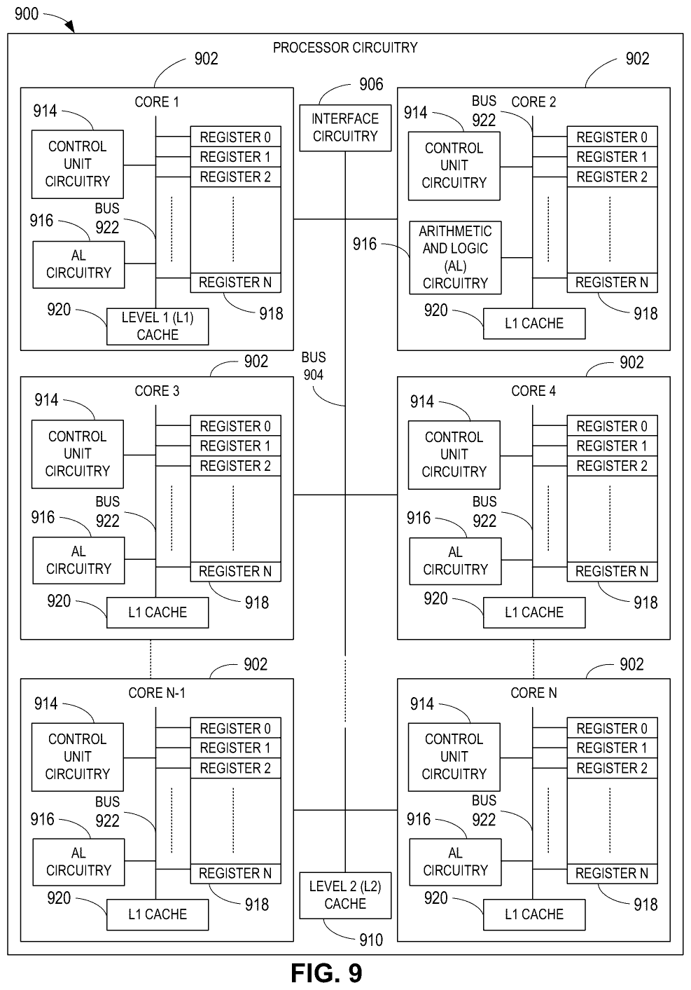

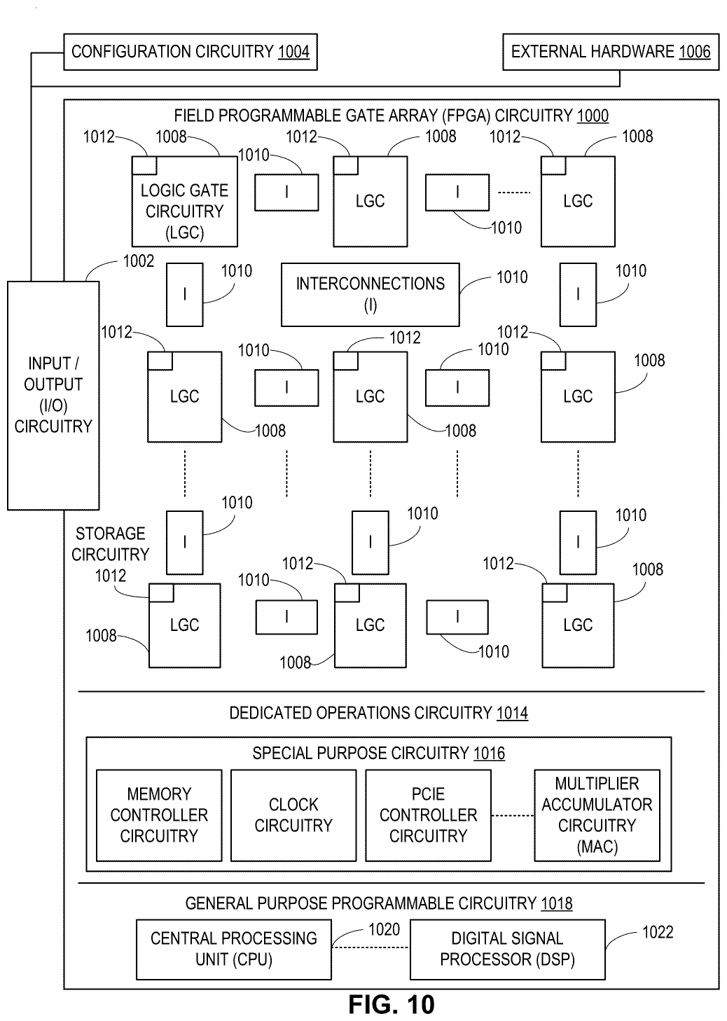

In some examples, the 3DGS initialization circuit 410 includes means for training a neural network to provide a neural representation. For example, the means for training the neural network may be implemented by the neural network training circuitry 420. In some examples, the neural network training circuitry 420 may be instantiated by programmable circuitry such as the example programmable circuitry 812 of FIG. 8. For instance, the neural network training circuitry 420 may be instantiated by the example microprocessor 900 of FIG. 9 executing machine executable instructions such as those implemented by at least blocks of FIGS. 6 and/or 7A-8D. In some examples, the neural network training circuitry 420 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the neural network training circuitry 420 may be instantiated by any other combination of hardware, software, and/or firmware. For example, the neural network training circuitry 420 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.)

configured and/or structured to execute some or all of the machine readable instructions and/or to perform some or all of the operations corresponding to the machine readable instructions without executing software or firmware, but other structures are likewise appropriate.

In some examples, the 3DGS initialization circuit 410 includes means for training ray selection. For example, the means for training ray selection may be implemented by the training ray selection circuitry 425. In some examples, the training ray selection circuitry 425 may be instantiated by programmable circuitry such as the example programmable circuitry 812 of FIG. 8. For instance, the training ray selection circuitry 425 may be instantiated by the example microprocessor 900 of FIG. 9 executing machine executable instructions such as those implemented by at least blocks of FIGS. 6 and/or 7A-8D. In some examples, the training ray selection circuitry 425 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the training ray selection circuitry 425 may be instantiated by any other combination of hardware, software, and/or firmware. For example, the training ray selection circuitry 425 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the 3DGS initialization circuit 410 includes means for determining a position of an initial 3D gaussian splat. For example, the means for determining a position of an initial 3D gaussian splat may be implemented by the gaussian position determination circuitry 430. In some examples, the gaussian position determination circuitry 430 may be instantiated by programmable circuitry such as the example programmable circuitry 812 of FIG. 8. For instance, the gaussian position determination circuitry 430 may be instantiated by the example microprocessor 900 of FIG. 9 executing machine executable instructions such as those implemented by at least blocks of FIGS. 6 and/or 7A-8D. In some examples, the gaussian position determination circuitry 430 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the gaussian position determination circuitry 430 may be instantiated by any other combination of hardware, software, and/or firmware. For example, the training ray selection circuitry 425 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the 3DGS initialization circuit 410 includes means for creating an initial 3D gaussian splat. For example, the means for creating an initial 3D gaussian splat may be implemented by the gaussian seed creation circuitry 435. In some examples, the gaussian seed creation circuitry 435 may be instantiated by programmable circuitry such as the example programmable circuitry 812 of FIG. 8. For instance, the gaussian seed creation circuitry 435 may be instantiated by the example microprocessor 900 of FIG. 9 executing machine executable instructions such as those implemented by at least blocks of FIGS. 6 and/or 7A-8D. In some examples, the gaussian seed creation circuitry 435 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the gaussian seed creation circuitry 435 may be instantiated by any other combination of hardware, software, and/or firmware. For example, the gaussian seed creation circuitry 435 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the 3DGS initialization circuit 410 is illustrated in FIG. 4, one or more of the elements, processes, and/or devices illustrated in FIG. 4 may be combined, divided, re-arranged, omitted, eliminated, and/or implemented in any other way. Further, the example neural network 200, the example 3DGS circuitry 405, the example neural network training circuitry 420, the example training ray selection circuitry 425, the example gaussian position determination circuitry 430, the example gaussian seed creation circuitry 435, and/or, more generally, the example 3DGS initialization circuit 410 of FIG. 4, may be implemented by hardware alone or by hardware in combination with software and/or firmware. Thus, for example, any of the example neural network 200, the example 3DGS circuitry 405, the example neural network training circuitry 420, the example training ray selection circuitry 425, the example gaussian position determination circuitry 430, the example gaussian seed creation circuitry 435, and/or, more generally, the example 3DGS initialization circuit 410, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example 3DGS initialization circuit 410 may include one or more elements, processes, and/or devices in addition to, or instead of, those illustrated in FIG. 4, and/or may include more than one of any or all of the illustrated clements, processes and devices.

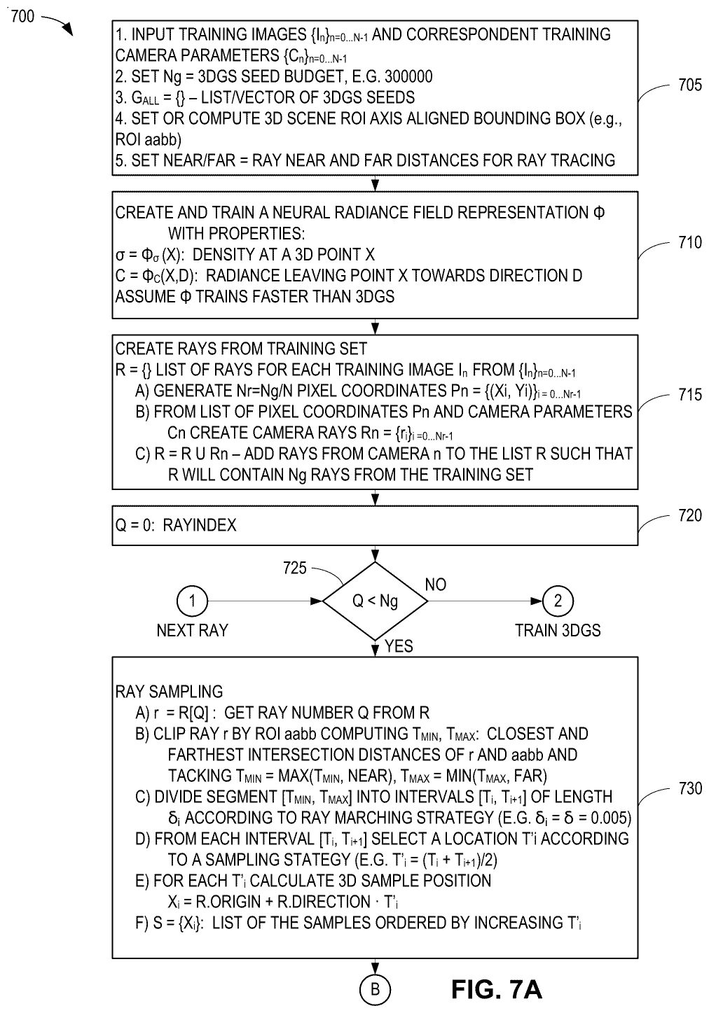

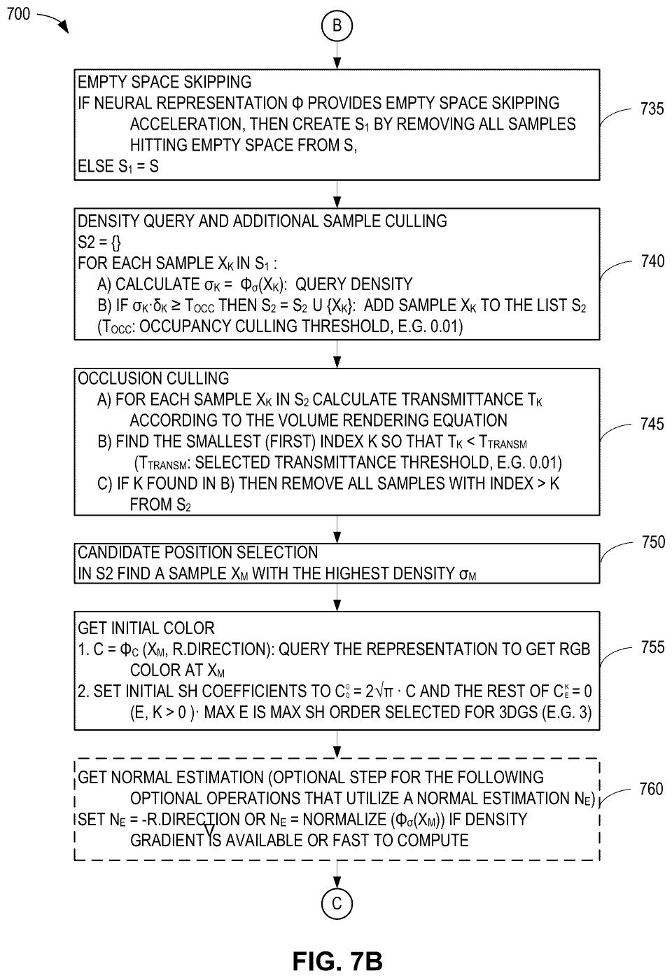

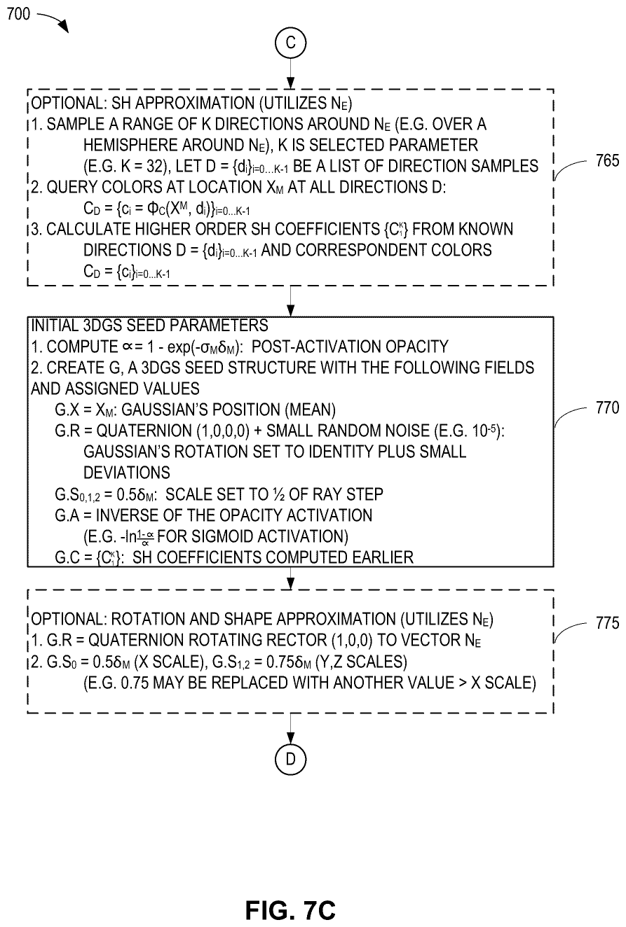

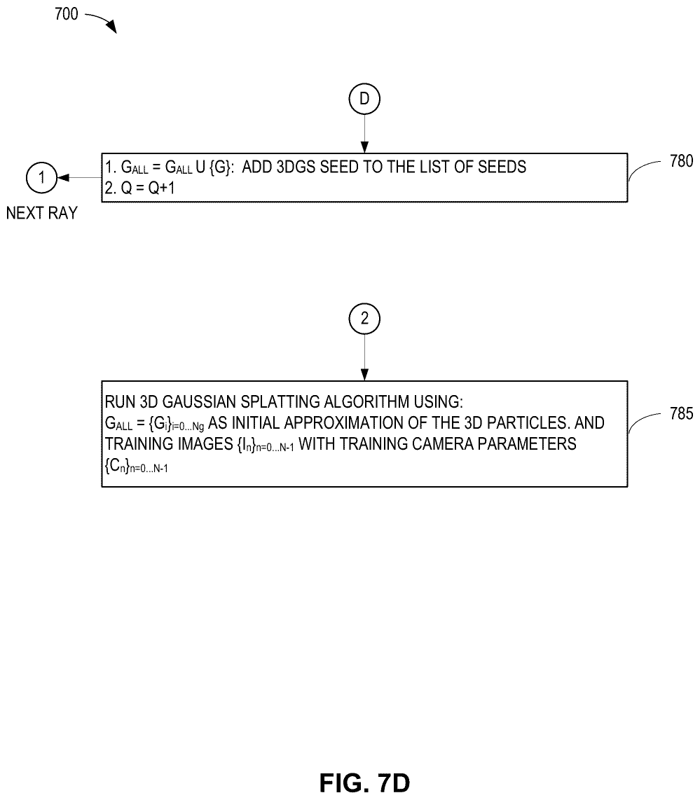

Flowchart(s) representative of example machine readable instructions, which may be executed by programmable circuitry to implement and/or instantiate the 3DGS initialization circuit 410 of FIG. 4 and/or representative of example operations which may be performed by programmable circuitry to implement and/or instantiate the 3DGS initialization circuit 410 of FIG. 4, are shown in FIGS. 6 and 7A-7D. The machine readable instructions may be one or more executable programs or portion(s) of one or more executable programs for execution by programmable circuitry such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically crasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 6 and 7A-7D, many other methods of implementing the example 3DGS initialization circuit 410 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6 and 7A-7D may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 6 is a flowchart representative of example machine readable instructions and/or example operations 600 that may be executed, instantiated, and/or performed by programmable circuitry to implement the 3DGS initialization circuit 410 of FIG. 4. The example machine-readable instructions and/or the example operations 600 of FIG. 6 begin at block 605 at which training ray selection circuitry 425 of the 3DGS initialization circuit 410 obtains a subset of training rays to be used to generate the set of initial 3D gaussian splats. At block 605, the training ray selection circuitry 425 selects the subset of training rays from the training rays used to train a neural representation of the scene, as described above.

At block 610, the 3DGS initialization circuit 410 iterates over the training rays in the subset. For example, at block 615, the gaussian position determination circuitry 430 of the 3DGS initialization circuit 410 obtains, as described above, optical density values from the trained neural representation for location sample points along the given training ray, with the location sample points based on a segment length. At block 620, the gaussian position determination circuitry 430 identifies, based on the optical density values, one of the location sample points of the given training ray to be a location of a corresponding initial 3D gaussian splat (such that each training ray results in a corresponding initial 3D gaussian splat), as described above.

At block 625, the gaussian seed creation circuitry 435 of the 3DGS initialization circuit 410 obtains a color value associated with the location of the initial 3D gaussian splat (determined at block 620) from the trained neural representation (e.g., with a query based on the location sample point corresponding to the location of the initial 3D gaussian splat and a direction of the given training ray). At block 630, the gaussian seed creation circuitry 435 sets parameters of the initial 3D gaussian splat based on the location sample point corresponding to the location of the initial 3D gaussian splat, the optical density value corresponding to that location sample point, the color value and the segment length, as described above.

At block 635, the 3DGS initialization circuit 410 continues iterating over the training rays in the subset. After processing of the training rays completes and the set of initial 3G gaussian splats is generated, processing proceeds to block 640. At block 640, the 3DGS circuitry 405 generates a 3D gaussian splat representation of the scene based on the set of initial 3D gaussian splats corresponding to the training rays and training images that were used to train the neural representation, as described above. The example machine readable instructions and/or example operations 600 then end.

FIGS. 7A-7D collectively are a flowchart representative of second example machine readable instructions and/or example operations 700 that may be executed, instantiated, and/or performed by programmable circuitry to implement the 3DGS initialization circuit 410 of FIG. 4. The example machine-readable instructions and/or the example operations 700 of FIGS. 7A-7D begin at block 705 of FIG. 7A, at which the 3DGS initialization circuit 410 sets the 3DGS seed budget Ng corresponding to the number of initial 3D gaussian splats to be generated by the 3DGS initialization circuit 410. At block 705, the 3DGS initialization circuit 410 also accesses training images and camera parameters to be used to train a neural representation of a scene and to generate a 3DGS representation of the scene, and also performs other initialization operations as shown.

At block 710, the neural network training circuitry 420 of the 3DGS initialization circuit 410 trains the neural network 200 to provide a neural representation of the scene, as described above. At block 715, the training ray selection circuitry 425 of the 3DGS initialization circuit 410 selects a subset of training rays to be used to generate the set of initial 3G gaussian splats to be used to initialize generation the 3DGS representation of the scene. As described above, at block 715 the training ray selection circuitry 425 selects the subset of training rays to correspond to the number N_{g} of initial 3G gaussian splats to be generated. Furthermore, in the illustrated example, the training ray selection circuitry 425 divides the subset of training rays evenly across the set of N training images used to train the neural representation, such that the subset of N_{g} training rays includes a respective subset of Nᵣ=N_{g}/N training rays for each training image.

At block 720, the 3DGS initialization circuit 410 begins processing the first training ray in the subset determined at block 715. At block 725, the 3DGS initialization circuit 410 determines whether there are additional training rays to process. If so, at block 730, the gaussian position determination circuitry 430 of the 3DGS initialization circuit 410 samples the current training ray based on a segment length δ, as described above, to obtain a set of location sample points for the current training ray. At block 735 of FIG. 7B, the gaussian position determination circuitry 430 discards those location sample points that correspond to empty space in the neural representation of the scene. At block 740, the gaussian position determination circuitry 430 updates the set of location sample points for the current training ray to include only those location sample points for which the trained neural representation implemented by the neural network 200 returns optical densities satisfying a threshold. At block 745, the gaussian position determination circuitry 430 further culls the set of location sample points for the current training ray by removing those location sample points that are occluded in the trained neural representation. At block 750, the gaussian position determination circuitry 430 then selects, from the set or remaining location sample points for the current training ray, the location sample point having the highest optical density and sets that location sample point to be a location of an initial 3D gaussian splat, as described above.

At block 755, the gaussian seed creation circuitry 435 of the 3DGS initialization circuit 410 obtains a color value associated with the location of the initial 3D gaussian splat (determined at block 750) from the trained neural representation (e.g., with a query based on the location sample point corresponding to the location of the initial 3D gaussian splat and a direction of the given training ray). At block 760, the gaussian seed creation circuitry 435 estimates a surface normal for the initial 3D gaussian splat, as described above. At block 765 of FIG. 7C, the gaussian seed creation circuitry 435 optionally determines higher order spherical harmonics for the color of the initial 3D gaussian splat based on the estimated surface normal obtained at block 760, as described above. At block 770, the gaussian seed creation circuitry 435 sets parameters of the initial 3D gaussian splat based on the location sample point corresponding to the location of the initial 3D gaussian splat, the optical density value corresponding to that location sample point, the color value and the segment length, as described above. At block 775, the gaussian seed creation circuitry 435 optionally sets the scale and rotation parameters of the initial 3D gaussian splat based on the estimated surface normal obtained at block 760, as described above.

At block 780 of FIG. 7D, the gaussian seed creation circuitry 435 includes the initial 3D gaussian splat generated for the current training ray in the set of initial 3D gaussian splats. The 3DGS initialization circuit 410 then continues iterating to the next training ray in the subset. For example, returning to block 725 of FIG. 7A, the 3DGS initialization circuit 410 determines whether there are additional training rays to process. If so, processing proceeds to block 730 and blocks subsequent thereto at which an initial 3D gaussian splat is generated for the next training ray. However, if all training rays have been processed and, thus, the set of initial 3D gaussian splats is complete, processing proceeds to block 785 of FIG. 7D at which the 3DGS circuitry 405 generates a 3D gaussian splat representation of the scene based on the set of initial 3D gaussian splats corresponding to the training rays and training images that were used to train the neural representation, as described above. The example machine readable instructions and/or example operations 700 then end.

FIG. 8 is a block diagram of an example programmable circuitry platform 800 structured to execute and/or instantiate the example machine-readable instructions and/or the example operations of FIGS. 6 and 7A-7D to implement the 3DGS initialization circuit 410 of FIG. 4. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the neural network training circuitry 420, the training ray selection circuitry 425, the gaussian position determination circuitry 430, the gaussian seed creation circuitry 435, and/or, more generally, the 3DGS initialization circuit 410. In some examples, the 812 also implements the neural network 200 and/or example 3DGS circuitry 405.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816. In some examples, the volatile memory 814 implements the training data storage 425.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. In some examples, one or more of the mass storage discs or devices 828 implement the training data storage 425.

The machine readable instructions 832, which may be implemented by the machine readable instructions of FIGS. 6 and 7A-7D, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 6 and 7A-7D to effectively instantiate the circuitry of FIG. 4 as logic circuits to perform operations corresponding to those machine readable instructions. In some such examples, the circuitry of FIG. 4 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 6 and 7A-7D.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (12C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowchart(s) of FIGS. 6 and 7A-7D but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 6 and 7A-7D. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 6 and 7A-7D. As such, the FPGA circuitry 1000 may be configured and/or structured to effectively instantiate some or all of the operations/functions corresponding to the machine readable instructions of the flowchart(s) of FIGS. 6 and 7A-7D as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIGS. 6 and 7A-7D faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIGS. 6 and 7A-7D and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine readable instructions represented by the flowchart(s) of FIGS. 6 and 7A-7D to perform first operation(s)/function(s), the FPGA circuitry 1000 of FIG. 10 may be configured and/or structured to perform second operation(s)/function(s) corresponding to a second portion of the machine readable instructions represented by the flowcharts of FIGS. 6 and 7A-7D, and/or an ASIC may be configured and/or structured to perform third operation(s)/function(s) corresponding to a third portion of the machine readable instructions represented by the flowcharts of FIGS. 6 and 7A-7D.

It should be understood that some or all of the circuitry of FIG. 4 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 4 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 4 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

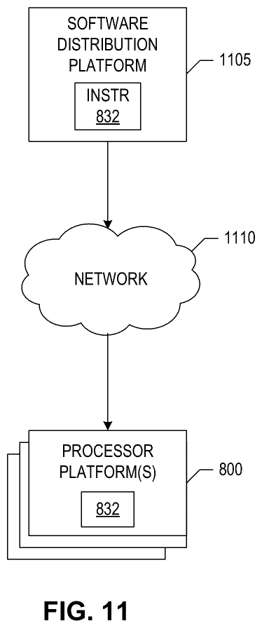

A block diagram illustrating an example software distribution platform 1105 to distribute software such as the example machine readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions of FIGS. 6 and 7A-7D, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIGS. 6 and 7A-7D, may be downloaded to the example programmable circuitry platform 800, which is to execute the machine readable instructions 832 to implement the 3DGS initialization circuit 410. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time +1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that implement three dimensional gaussian splatting initialization based on trained neural radiance field representations. Disclosed systems, apparatus, articles of manufacture, and methods improve the efficiency of using a computing device by exploiting the fast training capabilities of hash grids and neural radiance field representations, which allow spatial queries of optical density/opacity and possibly radiance/color values or equivalents of such values, to create a neural representation of a 3D scene from multiple input images. Disclosed systems, apparatus, articles of manufacture, and methods then use this trained neural representation to populate a relatively dense set of initial 3D gaussian splats that correspond closely to the actual geometry of the modelled 3D scene. The resulting initial set of 3D gaussian splats is used as a starting point to generate the 3DGS representation of the scene, which can converge to the 3DGS representation substantially faster than prior approaches, as the overall training time is dramatically reduced. Disclosed systems, apparatus, articles of manufacture, and methods are accordingly directed to one or more improvement(s) in the operation of a machine such as a computer or other electronic and/or mechanical device.

Further examples and combinations thereof include the following. Example 1 includes an apparatus comprising interface circuitry, computer readable instructions, and at least one processor circuit to be programmed by the computer readable instructions to determine a location for an initial three-dimensional (3D) gaussian splat based on optical densities obtained from a trained neural representation of a scene, the optical densities associated with location sample points along a training ray used to train the neural representation, and set parameters of the initial 3D gaussian splat based on one of the optical densities associated with the location of the initial 3D gaussian splat and a color value obtained from the trained neural representation, the color value associated with the location of the initial 3D gaussian splat, the initial 3D gaussian splat to be used to generate a 3D gaussian splat representation of the scene.

Example 2 includes the apparatus of example 1, wherein one or more of the at least one processor circuit is to determine the location of the initial 3D gaussian splat to be a first one of the location sample points along the training ray that is associated with a largest one of the optical densities.

Example 3 includes the apparatus of example 1 or example 2, wherein one or more of the at least one processor circuit is to query the trained neural representation based on the first one of the location sample points and a direction of the training ray to obtain the color value associated with the location of the initial 3D gaussian splat.

Example 4 includes the apparatus of any one of examples 1 to 3, wherein one or more of the at least one processor circuit is to set a mean of the initial 3D gaussian splat based on the first one of the location sample points along the training ray.

Example 5 includes the apparatus of any one of examples 1 to 4, wherein one or more of the at least one processor circuit is to set a zero order spherical harmonic parameter of the initial 3D gaussian splat based on the color value obtained from the trained neural representation.

Example 6 includes the apparatus of any one of examples 1 to 5, wherein the location sample points are based on a segment length used to sample the training ray, and one or more of the at least one processor circuit is to set a post-activation opacity parameter of the initial 3D gaussian splat based on the segment length and the one of the optical densities associated with the location of the initial 3D gaussian splat.

Example 7 includes the apparatus of any one of examples 1 to 6, wherein the location sample points are based on a segment length used to sample the training ray, and one or more of the at least one processor circuit is to set a post-activation scale parameter of the initial 3D gaussian splat based on the segment length.

Example 8 includes the apparatus of any one of examples 1 to 7, wherein the initial 3D gaussian splat is a first initial 3D gaussian splat, the training ray is a first training ray, and the one or more of the at least one processor circuit is to select a subset of training rays from a plurality of training rays used to train the neural representation, a number of training rays in the subset corresponding to a number of initial 3D gaussian splats in a set of initial 3D gaussian splats to be used to generate the 3D gaussian splat representation of the scene, the subset of training rays including the first training ray, and generate the set of initial 3D gaussian splats based on the subset of training rays, ones of the set of initial 3D gaussian splats corresponding respectively to ones of the subset of training rays, the set of initial 3D gaussian splats including the first initial 3D gaussian splat.

Example 9 includes the apparatus of any one of examples 1 to 8, wherein one or more of the at least one processor circuit is to generate the 3D gaussian splat representation of the scene based on the set of initial 3D gaussian splats and training images corresponding to multiple view of the scene, the training images used to train the neural representation of the scene.

Example 10 includes the apparatus of any one of examples 1 to 9, wherein the subset of training rays includes a first subset of training rays corresponding to a first one of the views and a second subset of training rays corresponding to a second one of the views.

Example 11 includes at least one non-transitory computer readable medium comprising computer readable instructions to cause at least one processor circuity to at least determine a location for an initial three-dimensional (3D) gaussian splat based on optical densities obtained from a trained neural representation of a scene, the optical densities associated with location sample points along a training ray used to train the neural representation, and set parameters of the initial 3D gaussian splat based on one of the optical densities associated with the location of the initial 3D gaussian splat and a color value obtained from the trained neural representation, the color value associated with the location of the initial 3D gaussian splat, the initial 3D gaussian splat to be used to generate a 3D gaussian splat representation of the scene.

Example 12 includes the at least one non-transitory computer readable medium of example 11, wherein the instructions are to cause one or more of the at least one processor circuit to determine the location of the initial 3D gaussian splat to be a first one of the location sample points along the training ray that is associated with a largest one of the optical densities.

Example 13 includes the at least one non-transitory computer readable medium of example 11 or example 12, wherein the instructions are to cause one or more of the at least one processor circuit to query the trained neural representation based on the first one of the location sample points and a direction of the training ray to obtain the color value associated with the location of the initial 3D gaussian splat, set a mean of the initial 3D gaussian splat based on the first one of the location sample points along the training ray, and set a zero order spherical harmonic parameter of the initial 3D gaussian splat based on the color value obtained from the trained neural representation.

Example 14 includes the at least one non-transitory computer readable medium of any one of examples 11 to 13, wherein the location sample points are based on a segment length used to sample the training ray, and the instructions are to cause one or more of the at least one processor circuit to set a post-activation opacity parameter of the initial 3D gaussian splat based on the segment length and the one of the optical densities associated with the location of the initial 3D gaussian splat, and set a post-activation scale parameter of the initial 3D gaussian splat based on the segment length.

Example 15 includes the at least one non-transitory computer readable medium of any one of examples 11 to 14, wherein the initial 3D gaussian splat is a first initial 3D gaussian splat, the training ray is a first training ray, and the instructions are to cause one or more of the at least one processor circuit to select a subset of training rays from a plurality of training rays used to train the neural representation, a number of training rays in the subset corresponding to a number of initial 3D gaussian splats in a set of initial 3D gaussian splats to be used to generate the 3D gaussian splat representation of the scene, the subset of training rays including the first training ray, and generate the set of initial 3D gaussian splats based on the subset of training rays, ones of the set of initial 3D gaussian splats corresponding respectively to ones of the subset of training rays, the set of initial 3D gaussian splats including the first initial 3D gaussian splat.

Example 16 includes a method to generate an initial three-dimensional (3D) gaussian splat based on a trained neural representation of a scene, the method comprising identifying, by at least one processor circuit programmed by at least one instruction, a location for the initial 3D gaussian splat based on optical densities obtained from the trained neural representation of the scene, the optical densities associated with location sample points along a training ray used to train the neural representation, setting, by one or more of the at least one processor circuit, parameters of the initial 3D gaussian splat based on one of the optical densities associated with the location of the initial 3D gaussian splat and a color value obtained from the trained neural representation, the color value associated with the location of the initial 3D gaussian splat, the initial 3D gaussian splat to be used to generate a 3D gaussian splat representation of the scene, and generating the 3D gaussian splat representation of the scene based on the initial 3D gaussian splat and training images corresponding to multiple view of the scene, the training images used to train the neural representation of the scene.

Example 17 includes the method of example 16, wherein the identifying of the location of the initial 3D gaussian splat includes determining the location of the initial 3D gaussian splat to be a first one of the location sample points along the training ray that is associated with a largest one of the optical densities.

Example 18 includes the method of example 16 or example 17, including querying the trained neural representation based on the first one of the location sample points and a direction of the training ray to obtain the color value associated with the location of the initial 3D gaussian splat, and wherein the setting of the parameters of the initial 3D gaussian splat includes setting a mean of the initial 3D gaussian splat based on the first one of the location sample points along the training ray, and setting a zero order spherical harmonic parameter of the initial 3D gaussian splat based on the color value obtained from the trained neural representation.

Example 19 includes the method of any one of examples 16 to 18, wherein the location sample points are based on a segment length used to sample the training ray, and the setting of the parameters of the initial 3D gaussian splat includes setting a post-activation opacity parameter of the initial 3D gaussian splat based on the segment length and the one of the optical densities associated with the location of the initial 3D gaussian splat, and setting a post-activation scale parameter of the initial 3D gaussian splat based on the segment length.

Example 20 includes the method of any one of examples 16 to 19, wherein the initial 3D gaussian splat is a first initial 3D gaussian splat, the training ray is a first training ray, and including selecting a subset of training rays from a plurality of training rays used to train the neural representation, a number of training rays in the subset corresponding to a number of initial 3D gaussian splats in a set of initial 3D gaussian splats to be used to generate the 3D gaussian splat representation of the scene, the subset of training rays including the first training ray, and generating the set of initial 3D gaussian splats based on the subset of training rays, ones of the set of initial 3D gaussian splats corresponding respectively to ones of the subset of training rays, the set of initial 3D gaussian splats including the first initial 3D gaussian splat.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
computer readable instructions; and
at least one processor circuit to be programmed by the computer readable instructions to:
determine a location for an initial three-dimensional (3D) gaussian splat based on optical densities obtained from a trained neural representation of a scene, the optical densities associated with location sample points along a training ray used to train the neural representation; and
set parameters of the initial 3D gaussian splat based on one of the optical densities associated with the location of the initial 3D gaussian splat and a color value obtained from the trained neural representation, the color value associated with the location of the initial 3D gaussian splat, the initial 3D gaussian splat to be used to generate a 3D gaussian splat representation of the scene.

2. The apparatus of claim 1, wherein one or more of the at least one processor circuit is to determine the location of the initial 3D gaussian splat to be a first one of the location sample points along the training ray that is associated with a largest one of the optical densities.

3. The apparatus of claim 2, wherein one or more of the at least one processor circuit is to query the trained neural representation based on the first one of the location sample points and a direction of the training ray to obtain the color value associated with the location of the initial 3D gaussian splat.

4. The apparatus of claim 2, wherein one or more of the at least one processor circuit is to set a mean of the initial 3D gaussian splat based on the first one of the location sample points along the training ray.

5. The apparatus of claim 1, wherein one or more of the at least one processor circuit is to set a zero order spherical harmonic parameter of the initial 3D gaussian splat based on the color value obtained from the trained neural representation.

6. The apparatus of claim 1, wherein the location sample points are based on a segment length used to sample the training ray, and one or more of the at least one processor circuit is to set a post-activation opacity parameter of the initial 3D gaussian splat based on the segment length and the one of the optical densities associated with the location of the initial 3D gaussian splat.

7. The apparatus of claim 1,wherein the location sample points are based on a segment length used to sample the training ray, and one or more of the at least one processor circuit is to set a post-activation scale parameter of the initial 3D gaussian splat based on the segment length.

8. The apparatus of claim 1, wherein the initial 3D gaussian splat is a first initial 3D gaussian splat, the training ray is a first training ray, and the one or more of the at least one processor circuit is to:
select a subset of training rays from a plurality of training rays used to train the neural representation, a number of training rays in the subset corresponding to a number of initial 3D gaussian splats in a set of initial 3D gaussian splats to be used to generate the 3D gaussian splat representation of the scene, the subset of training rays including the first training ray; and
generate the set of initial 3D gaussian splats based on the subset of training rays, ones of the set of initial 3D gaussian splats corresponding respectively to ones of the subset of training rays, the set of initial 3D gaussian splats including the first initial 3D gaussian splat.

9. The apparatus of claim 8, wherein one or more of the at least one processor circuit is to generate the 3D gaussian splat representation of the scene based on the set of initial 3D gaussian splats and training images corresponding to multiple view of the scene, the training images used to train the neural representation of the scene.

10. The apparatus of claim 9, wherein the subset of training rays includes a first subset of training rays corresponding to a first one of the views and a second subset of training rays corresponding to a second one of the views.

11. At least one non-transitory computer readable medium comprising computer readable instructions to cause at least one processor circuity to at least:
determine a location for an initial three-dimensional (3D) gaussian splat based on optical densities obtained from a trained neural representation of a scene, the optical densities associated with location sample points along a training ray used to train the neural representation; and
set parameters of the initial 3D gaussian splat based on one of the optical densities associated with the location of the initial 3D gaussian splat and a color value obtained from the trained neural representation, the color value associated with the location of the initial 3D gaussian splat, the initial 3D gaussian splat to be used to generate a 3D gaussian splat representation of the scene.

12. The at least one non-transitory computer readable medium of claim 11, wherein the instructions are to cause one or more of the at least one processor circuit to determine the location of the initial 3D gaussian splat to be a first one of the location sample points along the training ray that is associated with a largest one of the optical densities.

13. The at least one non-transitory computer readable medium of claim 12, wherein the instructions are to cause one or more of the at least one processor circuit to:
query the trained neural representation based on the first one of the location sample points and a direction of the training ray to obtain the color value associated with the location of the initial 3D gaussian splat;
set a mean of the initial 3D gaussian splat based on the first one of the location sample points along the training ray; and
set a zero order spherical harmonic parameter of the initial 3D gaussian splat based on the color value obtained from the trained neural representation.

14. The at least one non-transitory computer readable medium of claim 11, wherein the location sample points are based on a segment length used to sample the training ray, and the instructions are to cause one or more of the at least one processor circuit to:
set a post-activation opacity parameter of the initial 3D gaussian splat based on the segment length and the one of the optical densities associated with the location of the initial 3D gaussian splat; and
set a post-activation scale parameter of the initial 3D gaussian splat based on the segment length.

15. The at least one non-transitory computer readable medium of claim 11, wherein the initial 3D gaussian splat is a first initial 3D gaussian splat, the training ray is a first training ray, and the instructions are to cause one or more of the at least one processor circuit to:
select a subset of training rays from a plurality of training rays used to train the neural representation, a number of training rays in the subset corresponding to a number of initial 3D gaussian splats in a set of initial 3D gaussian splats to be used to generate the 3D gaussian splat representation of the scene, the subset of training rays including the first training ray; and
generate the set of initial 3D gaussian splats based on the subset of training rays, ones of the set of initial 3D gaussian splats corresponding respectively to ones of the subset of training rays, the set of initial 3D gaussian splats including the first initial 3D gaussian splat.

16. A method to generate an initial three-dimensional (3D) gaussian splat based on a trained neural representation of a scene, the method comprising:
identifying, by at least one processor circuit programmed by at least one instruction, a location for the initial 3D gaussian splat based on optical densities obtained from the trained neural representation of the scene, the optical densities associated with location sample points along a training ray used to train the neural representation;
setting, by one or more of the at least one processor circuit, parameters of the initial 3D gaussian splat based on one of the optical densities associated with the location of the initial 3D gaussian splat and a color value obtained from the trained neural representation, the color value associated with the location of the initial 3D gaussian splat, the initial 3D gaussian splat to be used to generate a 3D gaussian splat representation of the scene; and
generating the 3D gaussian splat representation of the scene based on the initial 3D gaussian splat and training images corresponding to multiple view of the scene, the training images used to train the neural representation of the scene.

17. The method of claim 16, wherein the identifying of the location of the initial 3D gaussian splat includes determining the location of the initial 3D gaussian splat to be a first one of the location sample points along the training ray that is associated with a largest one of the optical densities.

18. The method of claim 17, including:
querying the trained neural representation based on the first one of the location sample points and a direction of the training ray to obtain the color value associated with the location of the initial 3D gaussian splat; and
wherein the setting of the parameters of the initial 3D gaussian splat includes:
setting a mean of the initial 3D gaussian splat based on the first one of the location sample points along the training ray; and
setting a zero order spherical harmonic parameter of the initial 3D gaussian splat based on the color value obtained from the trained neural representation.

19. The method of claim 16, wherein the location sample points are based on a segment length used to sample the training ray, and the setting of the parameters of the initial 3D gaussian splat includes:
setting a post-activation opacity parameter of the initial 3D gaussian splat based on the segment length and the one of the optical densities associated with the location of the initial 3D gaussian splat; and
setting a post-activation scale parameter of the initial 3D gaussian splat based on the segment length.

20. The method of claim 16, wherein the initial 3D gaussian splat is a first initial 3D gaussian splat, the training ray is a first training ray, and including:
selecting a subset of training rays from a plurality of training rays used to train the neural representation, a number of training rays in the subset corresponding to a number of initial 3D gaussian splats in a set of initial 3D gaussian splats to be used to generate the 3D gaussian splat representation of the scene, the subset of training rays including the first training ray; and
generating the set of initial 3D gaussian splats based on the subset of training rays, ones of the set of initial 3D gaussian splats corresponding respectively to ones of the subset of training rays, the set of initial 3D gaussian splats including the first initial 3D gaussian splat.
